(19) United States
(12) Patent Application Publication
(10) Pub. No.: US 2022/0315788 A1
(43) Pub. Date: Oct. 6, 2022

(54) AQUEOUS POLYOLEFIN DISPERSION

(71) Applicant: ACTEGA DS GMBH, Bremen (DE)

(72) Inventors: Anna Maier, Bonn (DE); Anita Reichenbach, Bruchhausen-Vilsen (DE)

(21) Appl. No.: 17/641,604

(22) PCT Filed: Aug. 20, 2020
(86) PCT No.: PCT/EP2020/073331

§ 371 Date: Mar. 9, 2022

(30) Foreign Application Priority Data
Sep. 12, 2019 (EP) 19196845.2

(51) Int. Cl. C09D 123/08; C08L 23/08

(52) U.S. Cl. CPC C09D 123/0869; C08L 23/0869

(57) ABSTRACT

The invention relates to an aqueous polyolefin dispersion having a pH value from 8.6-12.5 containing a from 50 to 100 wt. % of an aqueous dispersion A comprising the following ingredients: i. from 31 to 90 wt. % of A1, a copolymer of ethylene and (meth)acrylic acid having a content of (meth)acrylic based groups of at least 11 wt. % based on the total weight of the copolymer or a mixture of different copolymers of ethylene and (meth)acrylic acid each having a content of (meth)acrylic based groups of at least 11 wt. % based on the total weight of the copolymer, ii. from 10 to 69 wt. % of A2, another olefinic structure units containing polymer, not being a copolymer of ethylene and (meth)acrylic acid, or a mixture of other olefinic structure units containing polymers not being a copolymers of ethylene and (meth)acrylic acid, and iii. from 0-35 wt. % of additive different from A1 and A2, b. from 0 to 50 wt. % of other ingredient(s) B, where compound B is a material dispersible or soluble in water and different from any of the ingredients of dispersion A wherein—the wt. % of A and B is based on the solid content of the whole aqueous polyolefin dispersion,—the wt. % of the ingredients of dispersion A is based on the solid content of dispersion A,—the sum of the wt. % of ingredients i to iii of dispersion A is 100% and wherein the pH of the dispersion is in the range of 9.5 to 11 and/or the dispersion contains, as an ingredient of B, more than 5 and less than 35 wt. % of PEG, based on the solid content of the whole aqueous dispersion.

The present invention relates to an aqueous polyolefin dispersion, and a process for the preparation thereof.

By mechanically dispersing of polyolefins in water so called secondary aqueous polyolefin dispersions are producible. These dispersions, when applied to various substrates, offer the special characteristics of polyolefins, including water/chemical resistance and heat sealability. Via mechanical dispersion technology water-borne dispersions of polymers are available.

In general, secondary polymer dispersions in a carrier liquid can be prepared by high shear mixing of the polymer in the carrier liquid at a temperature that is above the melting temperature of the polymer. According to US 2014/0255683 aqueous polyolefin dispersions which are suitable as coating compositions are available by a melt kneading method in which special thermoplastic and acid polyolefins are processed.

Heat sealability and mechanical stability are typically key properties of coated paper and coated carton board (both normally essentially containing plant fibers) that can be improved with the right choice of coating. High levels of mechanical stability and a good heat sealability are often needed for demanding packaging applications such as pet food bags, shopping bags, pizza boxes, hamburger wrappers, and the like. Polyolefins are widely used for paper coating, but are typically applied as a thermoplastic melt using extrusion coating techniques. The availability of water-based polyolefin dispersions provides an economical attractive alternative. The polyolefin dispersion can be applied to paper using conventional processes for water-based coatings, including various spraying techniques. In addition, the dispersion can be printed onto a paper web, such as by gravure printing, roll coating, etc.

It is noted that at present most paper based packaging material is recycled: for example in 2014 the paper recycling rate in Europe was 71.7%. Consequently, the provision of recyclable material is deemed to be a basic requirement for a commercial paper treatment technology. The process of waste paper recycling most often involves mixing used/old paper with water and chemicals to break it down. It is then chopped up and heated, which breaks it down further into strands of cellulose, a type of organic plant material; this resulting mixture is called pulp, or slurry. It is strained through screens, which remove any glue and plastic (especially from plastic-coated paper) that may still be in the mixture then cleaned, de-inked, bleached, and mixed with water. Then it can be made into new recycled paper.

U.S. Pat. No. 7,528,080 proposes the use of a special aqueous polyolefin dispersion for the impregnation of fibers so that corresponding treated textile articles are available having attractive mechanical and impregnating properties.

However, the above-mentioned technology on the one hand does not provide suitable polyolefin dispersions for paper applications and on the other hand is silent concerning the corresponding requirements in connection with the recyclability of the fiber material.

The problem addressed by the present invention is therefore that of providing an aqueous polyolefin dispersion that is suitable for paper treatment. Said paper treatment with the aqueous polyolefin dispersion should permit the manufacturing of high-quality paper articles, especially having beneficial characteristics in connection with mechanical stability, heat sealability and recyclability.

The solution to this problem is an aqueous polyolefin dispersion containing
a. from 50 to 100 wt. % of an aqueous dispersion A comprising the following ingredients:
   i. from 31 to 90 wt. % of A1, a copolymer of ethylene and (meth)acrylic acid having a content of (meth)acrylic based groups of at least 11 wt. % based on the total weight of the copolymer or a mixture of different copolymers of ethylene and (meth)acrylic acid each having a content of (meth)acrylic based groups of at least 11 wt. % based on the total weight of the copolymer,
   ii. from 10 to 69 wt. % of A2, another olefinic structure units containing polymer, not being a copolymer of ethylene and (meth)acrylic acid, or a mixture of other olefinic structure units containing polymers not being a copolymers of ethylene and (meth)acrylic acid, and
   iii. from 0-35 wt. % of additive different from A1 and A2,
b. from 0 to 50 wt. % of other ingredient(s) B,
wherein
   the wt. % of A and B is based on the solid content of the whole aqueous polyolefin dispersion,
   the wt. % of the ingredients of dispersion A is based on the solid content of dispersion A,
   the sum of the wt. % of ingredients i to iii of dispersion A is 100%.
and wherein one or both of the following restrictions are met:
   restriction 1) the pH of the dispersion is in the range of 9.5 to 11;
   restriction 2) the dispersion contains, as an ingredient of B, more than 5 and less than 35 wt. % of PEG, based on the solid content of the whole aqueous dispersion.

Treatment of paper or plant fiber articles with the aqueous polyolefin dispersion as specified above permits the preparation of paper articles having beneficial characteristics in connection with mechanical stability, heat sealability and recyclability. In particular, the requirement with respect to the pH of the dispersion or the presence of PEG is important for the recyclability of a paper article treated with the dispersion. It should be mentioned that the optimization of mechanical stability and heat sealability in practice often causes a deterioration of the recyclability properties. Consequently, the application of the polyolefin dispersion as specified above often also enables a kind of optimization compromise which ensures that all these three parameters are sufficient for the practice.

Recyclability of the treated paper material is assessed and verified with PTS Method RH:021/97 (Recyclability of paper, carton and board packages and of graphic print products): This method addresses recyclability of paper, paperboard and board for packaging materials and packages for generally accepted procedures for trouble-free production of recovered paper-based materials for packaging.

In yet a further embodiment the present invention relates to a process for the preparation of the aqueous polyolefin dispersion containing the steps a. to c. wherein
a. in a first step all solid components of dispersion A are intimately mixed at a temperature in the range of 50° C. to 200° C. after which a homogenous compound of all components is obtained,
b. in a next step the homogeneous compound is mixed with water, optional ingredient(s) B, and a neutralizing agent to adjust the pH value at a temperature which is 2 to 20° C. above the highest melting temperature of the components mixed in the first step until an aqueous dispersion is obtained and
c. the aqueous dispersion received in step b. is cooled down below a temperature which is below the melting temperature or the melting range (in case there is no uniform melting temperature of the A1 components) of A1.

Typically, the mixing in the first step is performed in a twin-screw extruder.

Normally, the mixing of the homogeneous compound with water, optional ingredient(s) B and the neutralizing compound is performed under elevated pressure.

The “premixing step” a. allows the preparation of an aqueous dispersion without the use of (additional) emulsifiers. It is advantageous to avoid these emulsifiers in the dispersion because of food safe reasons and properties in connection with heat sealability. The mixing of the homogeneous compound with water, optional ingredient(s) B and the neutralizing compound might be performed at a pressure which is higher than the vapour pressure of water at the mixing temperature.

The cooling step c. is important in order to receive a product having attractive heat sealability properties. Normally, the aqueous dispersion is cooled below 50° C., preferably below 30° C. Advantageously, the cooling of the aqueous dispersion is performed very quickly (normally at least 10° C. per minute, preferably at least 50° C. per minute) which additionally improves the heat sealability properties.

### Aqueous Polymer Dispersion A

The aqueous polyolefin dispersion used according to the current invention comprises an aqueous polymer dispersion A having the following ingredients:
i. from 31 to 90 wt. % of A1, a copolymer of ethylene and (meth)acrylic acid having a content of (meth)acrylic based groups of at least 11 wt. % based on the total weight of the copolymer or a mixture of different copolymers of ethylene and (meth)acrylic acid each having a content of (meth)acrylic based groups of at least 11 wt. % based on the total weight of the copolymer,
ii. from 10 to 69 wt. % of A2, another olefinic structure units containing polymer, not being a copolymer of ethylene and (meth)acrylic acid, or a mixture of other olefinic structure units containing polymers not being a copolymers of ethylene and (meth)acrylic acid, and
iii. from 0-35 wt. % of additive different from A1 and A2,
wherein the wt % of the ingredients of dispersion A is based on the solid content of dispersion A, and the sum of the wt. % of ingredients i to iii of dispersion A is 100%

Said copolymer of ethylene and (meth)acrylic acid A1 is preferably provided by copolymer of ethylene and (meth)acrylic acid which has sufficient properties in connection with melt processability, which is for example a copolymer having a Melt Flow Index (MFI) of between 2 to 600 g/10 min, as measured at 190° C. at a load of 2.16 kg.

In a special embodiment, the invention relates to an aqueous dispersion in which at least 70 Mol.-% of the copolymers of A1 have a content of (meth)acrylic based groups of at least 15 wt. % based on the total weight of the copolymer. In another beneficial embodiment of the present invention the aqueous dispersion A comprises from 41 to 90 wt. % of A1 and from 10 to 59 wt. % of A2 based on the solid content of dispersion A. According to these two embodiments of the present invention, aqueous dispersions are provided which are highly suitable for the use according to the present invention. Especially also a high dispersion stability is realized which is important for the relevant paper application. In this connection an aqueous dispersion A comprising less than 31 wt. % A1 provides a deteriorated quality.

Examples of suitable commercially available copolymers of polyethylene and (meth)acrylic acid A1 that can be used in the dispersion according to the present invention include Primacor™ 5980 (ex. Dow Chemicals), Nucrel® 2806 (ex. DuPont) and Escor™ 5200 (ex Exxonmobil).

The other polymer containing olefinic structure units A2 that is present in polymer dispersion A might be selected based upon the special (paper) application of the used aqueous dispersion. Said olefinic structure units are based on polymerized olefin monomers, normally selected from alkenes and/or polyenes. Often olefinic structure units containing polymers A2 are copolymers having olefinic structure units and non-olefinic structure units.

Suitable other olefinic structure units containing polymers A2 might be selected from the group consisting of copolymers of ethylene and vinyl acetate (EVA), copolymers of ethylene and vinyl acetate (EVA) modified with maleic anhydride, polyolefins modified with maleic anhydride, polyolefin elastomers, styrene butadiene block copolymers (SBS), ethylene-propylene-non-conjugated diene terpolymer (EPDM), maleic anhydride modified ethylene-propylene-non-conjugated diene terpolymer, copolymers of ethylene and propylene (EPM) and terpolymers of ethylene, propylene, and 1-butene. In a special embodiment A2 is selected from the group consisting of copolymers of ethylene and vinyl acetate (EVA) and copolymers of ethylene and vinyl acetate (EVA) modified with maleic anhydride. The vinyl acetate content of these copolymer species is normally of 25-60 wt. % based on the total weight of the copolymer.

The use of these other polymers (A2) typically provide improved haptic properties and/or additional better characteristics in connection with heat sealability. The improvement in respect to heat sealability is often combined with the enhancement of the corresponding sealing strength.

Examples of suitable commercially available other polymers A2 that can be used in polymer dispersion A according to the present invention include Polybond® 3000, Polybond 3349® and Royaltuf® (all ex Addivant), Orevac® T9305 (ex. Arkema), Affinity GA1950 (ex. Dow), Bynel® E418 (ex. DuPont), Vestoplast® 508, Vestoplast® 751 (both ex. Evonik), Escorene FL00328, Escorene AD0428EM1, Vistamax 6202 (all ex. ExxonMobil), and Kraton® D1157 (ex. Kraton).

The additive that can be present in the aqueous dispersion according to the present invention includes dispersing agents, rheology additives, adhesion promotors, tackifiers, defoamers, fillers, pigments and any other material that is known for use in polymer dispersions or polymer compositions. Examples of typical additives that can be used in the aqueous dispersion according to the present invention include stearic acid, oleic acid and other long chain carboxylic acids, clays, waxes, such as paraffin wax and polyolefin wax, and dioctyl sodium sulfosuccinate.

Ingredient(s) B is optionally present in the aqueous dispersion according to the present invention. Ingredient(s) B can be one or more compounds that are dispersible or soluble in water or a mixture of compounds that are dispersible or soluble in water and different from any of the ingredients of dispersion A. For example, ingredient(s) B can be added to improve the ability to recycle materials comprising the aqueous dispersion according to the present invention or materials or articles that are formed by evaporating the solvent from this dispersion. Ingredient(s) B can be an inorganic material or an organic material. For example, Ingredient(s) B might be a polymer not having olefinic structural units (like a polyether) or a mixture of polymers, dispersible or soluble in water.

It was found that, to obtain an aqueous dispersion that can be used to provide paper-based articles that are recyclable, the pH of the aqueous dispersion should be in the range of 9.5-11 and/or the dispersion should contain from more than 5 to less than 35 wt. % of polyethylene glycol, wherein the wt. % is based on the solid content of the whole aqueous dispersion When polyethylene is present it is a compound of ingredient(s) B

In a further embodiment of the present invention ingredient(s) B are present and comprises a recycling auxiliary component. The recycling auxiliary component is typically provided by polyvinyl pyrrolidone, polyvinyl alcohol, silica, and/or chalk.

In the process for the preparation of the aqueous polyolefin dispersion used according to the present invention the homogenized compound obtained in the first step is mixed with water, optional ingredient(s) B, and a neutralizing agent at a temperature which is 2 to 20° C. above the highest melting temperature of the components mixed in the first step until an aqueous dispersion is obtained wherein often all dispersed particles have a particle size below 60 μm. A temperature which is 2 to 20° C. above the highest melting temperature of the components mixed in the first step means a temperatures which is 2 to 20° C. above the highest melting temperature of any of the individual components that are mixed to obtain the homogenized compound. For example, if the homogenized compound is obtained by 3 ingredients, A1, A2 and A3, each having their own melting temperature (T_{MA1}, T_{MA2}, T_{MA3}), where T_{MA2}>T_{MA1}>T_{MA3}, 2 to 20° C. above the highest melting temperature means 2 to 20° C. above T_{MA2}.

The neutralizing agent that is used in the process for the preparation of the aqueous polyolefin dispersion according to the present invention can be any basic aqueous solution, for example an aqueous solution of NH₃, NaOH or KOH. However, preferably no NH₃ is used because stronger bases like alkali hydroxides are necessary in order to adjust the sufficient pH value. Typically, said aqueous polyolefin dispersion contains KOH and/or NaOH.

The size of the particles that are present in the aqueous polyolefin dispersion used according to the present invention are often <60 μm. This particle size can be measured by using a Microtrac S3500 laser diffraction system, using the wet dispersion module. For each measurement, 1 ml of a dispersion was added to the 1 l dispersing unit of the wet dispersion module, where the dispersing module was filled with water with a pH in the range of 7-10.

The liquid content of the aqueous polyolefin dispersion according to the present invention is variable and normally according to conventional polyolefin dispersions. Typically, as dispersion liquid exclusively water is used.

The process according to the present invention allows for the use of ingredients that are approved as indirect food additives, i.e. substances that may come into contact with food as part of packaging or processing equipment, but are not intended to be added directly to food. The ingredients are sometimes referred to as food safe materials or material suited for direct food contact. In this connection, “food safe” means that these materials satisfy the criteria of the European Union Regulation “EU 10-2011 for plastics intended to come into contact with food”. In one embodiment of the present invention, all ingredients that are present in the aqueous polymer dispersion are food safe materials or material suited for direct food contact.

In general, the aqueous polyolefin dispersion according to the present invention has the following properties:
Solid content 10-50 wt. %
Viscosity 30-10000 mPa*s
Storage stability≥6 months
Average particle size from 1 to 50 μm

The process according to the present invention provides a kind of premixing of (dry) components which is performed in the first step: All solid components of dispersion A, especially component A1 and A2 are intimately mixed at a temperature in the range of 50° C. to 200° C. after which a homogenous compound of all components is obtained. Typically, in the premixing step no water is used. Said premixing step seems to be the basis for the generation of hybrid particles containing both A1 and A2. In the next step the homogeneous compound provided in the premixing step is further mixed with water, preferably with compound B, and a neutralizing agent: The result is an aqueous polyolefin dispersion comprising dispersed hybrid particles containing both A1 the copolymer of polyethylene and (meth)acrylic acid having a content of (meth)acrylic based groups of at least 11 wt. % and A2 the another polymer, not being a copolymer of polyethylene and (meth)acrylic acid.

In order to provide experimental information regarding the composition of the dispersion as analytical methods especially Differential Scanning calorimetry (DSC) and/ or IR spectroscopy might be used. According to the said DSC method the melting temperatures (melting ranges) were determined on the one hand for the used raw materials (polymers) and on the other hand for the produced compounds (solid content of the dispersion). The melting ranges of the produced compounds were generally much broader than of the used raw materials.

### Definitions

Within the content of this description the following definitions are used
(meth)acrylic means acrylic and/or methacrylic;
A homogeneous polymer containing compound is a compound that shows no optical defects when cast into a film with a thickness in the range of 1 to 2 mm.

### Measurement Methods

The following measurement methods were used to characterize the individual components and the obtained products mentioned in this description:

Melt Flow Index (MFI) was determined in accordance with ISO 1133 in a Zwick/Roell extrusion plastometer. The MFI is measured at 190° C. at a load of 2.16 kg. For each measurement, 6 gr of material was heated for 5 minutes inside the measurement cylinder prior to the start of a measurement. The MFI is the average value for three portions.

The melting temperature of a component was determined using differential scanning calorimetry according to ISO 11357. For the measurement a Mettler Toledo DSCStar System was used. The measurements were carried out under nitrogen in a temperature range of −60 to 200° C. and a heating rate of 10 K/min.

The solid content of a dispersion was determined by heating 1 g of the dispersion in an aluminum cup during 30 minutes at 150° C. The solid content is the ratio between the weight of the sample after heating and before heating. The solid content is the average of 3 measurements.

The viscosity of a dispersion was measured using a Thermo Fisher Scientific HAAKE™ Rotation Rheometer RV1 at 20° C. using a double-cone DC60/2 Ti L configuration in combination with a MPC/DC60 geometry. The measurements were performed during 120 s at shear rates between 0 and 120 s⁻¹. The viscosity values at shear rate 114 s⁻¹ are evaluated.

The particle size was measured using a Microtrac S3500 laser diffraction system, using a wet dispersion module. For each measurement, 1 ml of a dispersion was added to the 1 l dispersing module, where the dispersing module was filled with water with a pH in the range of 7-10. The further settings are cell size 2 mm, ultra sound duration 60 s.

The pH value was determined by a pH meter PCE-228 of PCE Instruments accorded to DIN ISO 8975 of the undiluted dispersion.

The evidence of the raw materials were determined with a Thermo Fisher Scientific Nicolet iS5 FTIR-Spectrometer with iD5 ATR module and Zinc selenide crystal.

Normally, after treating a plant fiber preparation with the aqueous polyolefin dispersion according to the present invention at least substantially the water of the aqueous polyolefin dispersion is removed by drying.

### EXAMPLES

Various aqueous dispersions were prepared using the following procedure:
In a first step a compound was prepared by mixing and kneading the individual ingredients in a Leistritz ZSE 18 Maxx twin-screw extruder at a temperature in the range of 80-150° C. (temperature was selected based on the ingredients), where different temperature zones were created inside the extruder. The pressure inside the extruder was 35 bar maximum.
In a next step the extruded compound was fed into a Buchi 2 l Pressure reactor, equipped with a dissolver mixer operating at speeds between 100-1000 rpm. The dispersion was prepared at elevated temperature in the range of 90-150° C. at sometimes elevated pressure (additional pressure in the range of 0-100 bar). After the formation of a homogeneous dispersion the cooling of the mixture is essential. The cooling has to be quickly as possible at crystallization temperature of the polymers until maximum temperature of 40° C.

The ingredients and conditions for each example are given in Table 1 below.

TABLE 1

| Example | # 1 | # 2 | # 3 | # 4 | # 5* | # 6* |
|---|---|---|---|---|---|---|
| EAA #3 (wt. %) | 43.5 | 60 | 60 | 60 | 60 | 60 |
| EPM #82 (wt. %) | | | | 40 | | |
| RT #53 | | | | | | |
| RP EVA #2 (wt. %) | | 40 | | | 40 | 40 |
| EVA #4 (wt. %) | 29 | | 40 | | | |
| PVP #33 (wt. %) | 1.25 | | | | | |
| PEG #40 (wt. %) | 26.25 | | | | | |
| Solid content (%) | 31 | 31 | 32 | 29 | 27 | 30 |
| Base | NaOH | NaOH | NaOH | NaOH | NaOH | NH₃ |
| Temperature (° C.) | 90 | 90 | 90 | 120 | 90 | 100 |
| pH value | 9.5 | 10 | 9.7 | 9.6 | 9.2 | 8.5 |
| Recyleability | yes | yes | yes | yes | no | no |
| Sealing Strength (N/m) | 169 | 513 | 387 | 187 | 693 | 609 |

*Comparative example

EAA#3: PRIMACOR® 5980; dispersible polymer which is an ethylene acrylic acid copolymer (20 wt % comonomer), “DOW”

EPM#82: Dutral CO 034, ethylene propylene copolymer (28 wt % propylene), “Versalis”

RT #53: Lotader AX 8750, random terpolymer of ethylene, butylacrylate, glycidyl methacrylate (23-28 wt % butylacrylat), “Arkema”

RP EVA #2: OREVAC® T 9305, a random terpolymer of ethylene, vinyl acetate and maleic anhydride, “ARKEMA”

EVA #4: Escorene FL 00328, ethylene, vinyl acetate copolymer, “ExxonMobil”

PVP #33: Kollidon 90, polyvinylpyrrolidone, Mw: 790000-1350000, “BASF”

PEG#40: Polyethylenglycol 10000, Mw: 9000-12500, “Merck”

1. Aqueous polyolefin dispersion containing
a. from 50 to 100 wt. % of an aqueous dispersion A comprising the following ingredients:
i. from 31 to 90 wt. % of A1: a copolymer of ethylene and (meth)acrylic acid having a content of (meth)acrylic based groups of at least 11 wt. % based on the total weight of the copolymer, or a mixture of different copolymers of ethylene and (meth)acrylic acid, each copolymer of the mixture of different copolymers having a content of (meth)acrylic based groups of at least 11 wt. % based on the total weight of the copolymer,
ii. from 10 to 69 wt. % of A2: another polymer containing olefinic structure units, but not being a copolymer of ethylene and (meth)acrylic acid, or a mixture of other polymers containing olefinic structure units but not being copolymers of ethylene and (meth)acrylic acid, and
iii. from 0-35 wt. % of additive different from A1 and A2,
b. from 0 to 50 wt. % of other ingredient(s) B,
wherein
the wt. % of the aqueous dispersion A and the other ingredient(s) B is based on the solid content of the whole aqueous polyolefin dispersion,
the wt. % of the ingredients of the aqueous dispersion A is based on the solid content of the aqueous dispersion A,
the sum of the wt. % of ingredients i to iii of the aqueous dispersion A is 100%,
and wherein one or both of the following conditions are met:
1) the pH of the aqueous polyolefin dispersion is in the range of 9.5 to 11;
2) the aqueous polyolefin dispersion contains, as an ingredient of the other ingredient(s) B, more than 5 and less than 35 wt. % of PEG, based on the solid content of the whole aqueous polyolefin dispersion.

2. Aqueous polyolefin dispersion according to claim 1, wherein at least 70 Mol.-% of the copolymer of ethylene and (meth)acrylic acid or each copolymer of the mixture of different copolymers of ethylene and (meth)acrylic acid of A1 have a content of (meth)acrylic based groups of at least 15 wt. % based on the total weight of the copolymer.

3. Aqueous polyolefin dispersion according to claim 1, wherein the aqueous dispersion A comprises from 41 to 90 wt. % of A1 and from 10 to 59 wt. % of A2 based on the solid content of the aqueous dispersion A.

4. Aqueous polyolefin dispersion according to claim 1, further containing KOH and/or NaOH.

5. Aqueous polyolefin dispersion according to claim 1, wherein A2 includes one or more of a copolymer of ethylene and vinyl acetate (EVA), a copolymer of ethylene and vinyl acetate (EVA) modified with maleic anhydride, a polyolefin modified with maleic anhydride, a polyolefin elastomer, a styrene butadiene block copolymer (SBS), an ethylene-propylene-non-conjugated diene terpolymer (EPDM), a maleic anhydride modified ethylene-propylene-non-conjugated diene terpolymer, a copolymer of ethylene and propylene (EPM),and a terpolymer of ethylene, propylene, and 1-butene.

6. Aqueous polyolefin dispersion according to claim 1, wherein the aqueous polyolefin dispersion contains dispersed hybrid particles containing both A1 the copolymer of polyethylene and (meth)acrylic acid having a content of (meth)acrylic based groups of at least 11 wt. % and A2 the another polymer containing olefinic structure units but not being a copolymer of polyethylene and (meth)acrylic acid.

7. Process for the preparation of an aqueous polyolefin dispersion, the process comprising:
intimately mixing ingredients of an aqueous dispersion A at a temperature in the range of 50° C. to 200° C. after which a homogenous compound of the ingredients is obtained, the aqueous dispersion A comprising the ingredients:
i. from 31 to 90 wt. % of A1: a copolymer of ethylene and (meth)acrylic acid having a content of (meth)acrylic based groups of at least 11 wt. % based on the total weight of the copolymer, or a mixture of different copolymers of ethylene and (meth)acrylic acid, each copolymer of the mixture of different copolymers having a content of (meth)acrylic based groups of at least 11 wt. % based on the total weight of the copolymer,
ii. from 10 to 69 wt. % of A2: another polymer containing olefinic structure units but not being a copolymer of ethylene and (meth)acrylic acid, or a mixture of other polymers containing olefinic structure units but not being copolymers of ethylene and (meth)acrylic acid, and
iii. from 0-35 wt. % of additive different from A1 and A2,
mixing the homogeneous compound with water, optional other ingredient(s) B, and a neutralizing agent at a temperature which is 2 to 20° C. above the highest melting temperature of the components of the aqueous dispersion A until the aqueous polyolefin dispersion is obtained and
cooling down the aqueous polyolefin dispersion below a temperature which is below the melting temperature or the melting range of A1,
wherein the aqueous polyolefin dispersion comprises 50 to 100 wt. % of the aqueous dispersion A and from 0 to 50 wt. % of the optional other ingredient(s) B based on the solid content of the whole aqueous polyolefin dispersion,
the wt. % of the ingredients of the aqueous dispersion A is based on the solid content of the aqueous dispersion A,
the sum of the wt. % of ingredients i to iii of the aqueous dispersion A is 100%,
and one or both of the following conditions are met:
1) the pH of the aqueous polyolefin dispersion is in the range of 9.5 to 11;
2) the aqueous polyolefin dispersion contains, as an ingredient of the optional other ingredient(s) B, more than 5 and less than 35 wt. % of PEG, based on the solid content of the whole aqueous polyolefin dispersion.

8. A recyclable article comprising:
paper, and
the aqueous polyolefin dispersion according to claim 1 applied to the paper as a binder and/or as a coating composition, where the recyclability of the recyclable article is assessed and verified with PTS Method RH:021/97.

9. (canceled)
